(19) United States
(12) Patent Application Publication
(10) Pub. No.: US 2025/0227479 A1
(43) Pub. Date: Jul. 10, 2025

(54) CONTENT STREAMING APPLICATION AUTHENTICATION WITHOUT A SECOND SCREEN APPLICATION

(71) Applicant: Charter Communications Operating, LLC, St. Louis, MO (US)

(72) Inventors: Sarai Elaine Worsham, Littleton, CO (US); Wesley Alan Duff, Castle Rock, CO (US); Jonathan Dain Huggins, Littleton, CO (US); Keith Thomas Neubert, Castle Rock, CO (US); Brad D. Stitt, Denver, CO (US)

(21) Appl. No.: 18/408,218

(22) Filed: Jan. 9, 2024

(51) Int. Cl. H04W 12/72; H04L 9/32

(52) U.S. Cl. CPC H04W 12/72; H04L 9/3213

(57) ABSTRACT

An application authentication request is received from a content streaming application executing on a content streaming device. An authentication request that requests an authentication action for the content streaming application is sent to a front-end authentication system. An authentication message that identifies a uniform resource locator (URL) of a service provider login web page of a service provider for user entry of subscriber authentication credentials is received from the front-end authentication system. The authentication message includes a service provider authentication request. The service provider login web page is prevented from being presented on a display device. The service provider authentication request is sent to a service provider back-end authentication system. A service provider authentication response is received from the service provider back-end authentication system. A message that includes the service provider authentication response is sent to the front-end authentication system.

### BACKGROUND

Prior to presenting content, a content streaming application may request that the viewer enter authentication credentials to establish that the viewer has a valid subscription.

### SUMMARY

The examples disclosed herein automatically authenticate a connected TV (CTV) application initiated on a CTV device that is coupled to a customer premises equipment (CPE) such as a router or cable modem provisioned by the same service provider with which a user has a subscription.

In one example a method is provided. The method includes receiving, by an authentication intermediary executing on a computing device from a content streaming application executing on a content streaming device, a first application authentication request. The method further includes sending, by the authentication intermediary to a front-end authentication system, an authentication request that requests an authentication action for the content streaming application. The method further includes receiving, by the authentication intermediary from the front-end authentication system, an authentication message that identifies a uniform resource locator (URL) of a service provider login web page of a service provider for user entry of subscriber authentication credentials, the authentication message including a service provider authentication request. The method further includes preventing, by the authentication intermediary, the service provider login web page from being presented on a display device. The method further includes sending, by the authentication intermediary to a service provider back-end authentication system, the service provider authentication request. The method further includes receiving, by the authentication intermediary from the service provider back-end authentication system, a service provider authentication response. The method further includes sending, by the authentication intermediary to the front-end authentication system, a message that includes the service provider authentication response.

In another example a computing device is provided. The computing device includes a memory and a processor device coupled to the memory and operable to receive, from a content streaming application executing on a content streaming device, a first application authentication request. The processor device is further operable to send, to a front-end authentication system, an authentication request that requests an authentication action for the content streaming application. The processor device is further operable to receive, from the front-end authentication system, an authentication message that identifies a URL of a service provider login web page of a service provider for user entry of subscriber authentication credentials, the authentication message including a service provider authentication request. The processor device is further operable to prevent the service provider login web page from being presented on a display device. The processor device is further operable to send, to a service provider back-end authentication system, the service provider authentication request. The processor device is further operable to receive, from the service provider back-end authentication system, a service provider authentication response. The processor device is further operable to send, to the front-end authentication system, a message that includes the service provider authentication response.

In another example a non-transitory computer-readable storage medium is provided. The non-transitory computer-readable storage medium includes executable instructions operable to cause one or more processor devices to receive, from a content streaming application executing on a content streaming device, a first application authentication request. The instructions are further operable to cause the one or more processor devices to send, to a front-end authentication system, an authentication request that requests an authentication action for the content streaming application. The instructions are further operable to cause the one or more processor devices to receive, from the front-end authentication system, an authentication message that identifies a URL of a service provider login web page of a service provider for user entry of subscriber authentication credentials, the authentication message including a service provider authentication request. The instructions are further operable to cause the one or more processor devices to prevent the service provider login web page from being presented on a display device. The instructions are further operable to cause the one or more processor devices to send, to a service provider back-end authentication system, the service provider authentication request. The instructions are further operable to cause the one or more processor devices to receive, from the service provider back-end authentication system, a service provider authentication response. The instructions are further operable to cause the one or more processor devices to send, to the front-end authentication system, a message that includes the service provider authentication response.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which content streaming application authentication without a second screen application can be implemented according to some examples;

FIG. 2 is a flowchart of a method for content streaming application authentication without a second screen application according to one implementation;

FIGS. 3A-3C illustrate a sequence diagram illustrating actions taken by and messages communicated between components illustrated in FIG. 1 to implement content streaming application authentication without a second screen application according to some examples;

FIGS. 4A-4B illustrate a sequence diagram illustrating actions taken by and messages communicated between components illustrated in FIG. 1 to implement content streaming application authentication with a second screen application according to some examples; and

FIG. 5 is a block diagram of a computing device suitable for implementing examples disclosed herein according to some implementations.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A “connected television (CTV) application” is a content streaming application. In some implementations, a CTV application may be a TV Everywhere streaming application that allows an individual to watch a content “channel” (e.g., the AMC® channel) on different device platforms after authenticating with their television service provider. In some implementations, the channel may be one of a plurality of channels that are provided by the television service provider via a single content streaming application when the subscriber is at home. A CTV application typically executes on a CTV device that presents the content streamed by the CTV application on a display. Examples of CTV devices are media streaming devices such as a Roku® CTV device, an Amazon® Fire Stick CTV device, a Google® Chromecast® CTV device, an Apple® AppleTV CTV device, an Xbox® CTV device, or a smart TV that executes CTV applications. CTV devices often do not provide web browser support, or do not easily facilitate concurrent presentation of content from the CTV application and a web browser on a single display.

A CTV application may require authentication prior to presenting streaming content. For example, when the CTV application is first initiated on a CTV device, the CTV application may, for authentication purposes, present, on the display device, a registration code and direct the user to a uniform resource locator (URL) of a web application, sometimes referred to as a “second screen application”. The user may use a second device, such as a laptop computing device, smartphone or the like, to enter the URL and initiate the second screen application. The second screen application requests entry of the registration code, and then subsequently requests that the user select a particular service provider, such as a television content provider. For example, the second screen application may present a scrollable list of known service providers. In some implementations, the registration code itself may identify the particular service provider, and subsequent to entering the registration code, the user may be immediately directed to a particular login web application of the service provider. Either way, the user is prompted for the authentication credentials for the user's subscription with the service provider. The user enters the appropriate authentication credentials, and the second screen application directly or indirectly communicates with the CTV application, informing the CTV application that the user has the appropriate rights to view the content. The CTV application then typically presents the home screen of the CTV application to allow the user to view content provided by the CTV application.

A service provider may provide a broadband network access service (sometimes referred to herein as “Internet access”) to a user of a CTV application via a subscription, such as via a monthly subscription fee. The broadband network access service may be, for example, cable or fiber broadband network access service. To provide the broadband network access service, the service provider may install or provision a customer premises equipment (CPE) such as a gateway router and/or cable or fiber modem at the subscriber's premises.

A user may initiate a CTV application on a CTV device that is coupled to a CPE provided by the same service provider with which the user has a subscription that authorizes use of the CTV application. For example, the user may purchase a CTV device such as a Roku@ CTV device and connect the Roku CTV device to the local area network (LAN) of the subscriber. In such situations, it would be convenient for the user if the service provider could automatically recognize that the CTV application has initiated the authentication sequence on such a CTV device and, if the user has the appropriate subscription, automatically authenticate the user without the need for user input. This would eliminate the need for the user to access a second screen application on a separate computing device and enter a registration code and subscriber authentication credentials.

The examples disclosed herein automatically authenticate a CTV application initiated on a CTV device that is coupled to a CPE, such as a router or cable modem, provided by the same service provider with which the user has the subscription that authorizes use of the CTV application, which would otherwise require a second screen login or other customer-visible intermediary to facilitate the login.

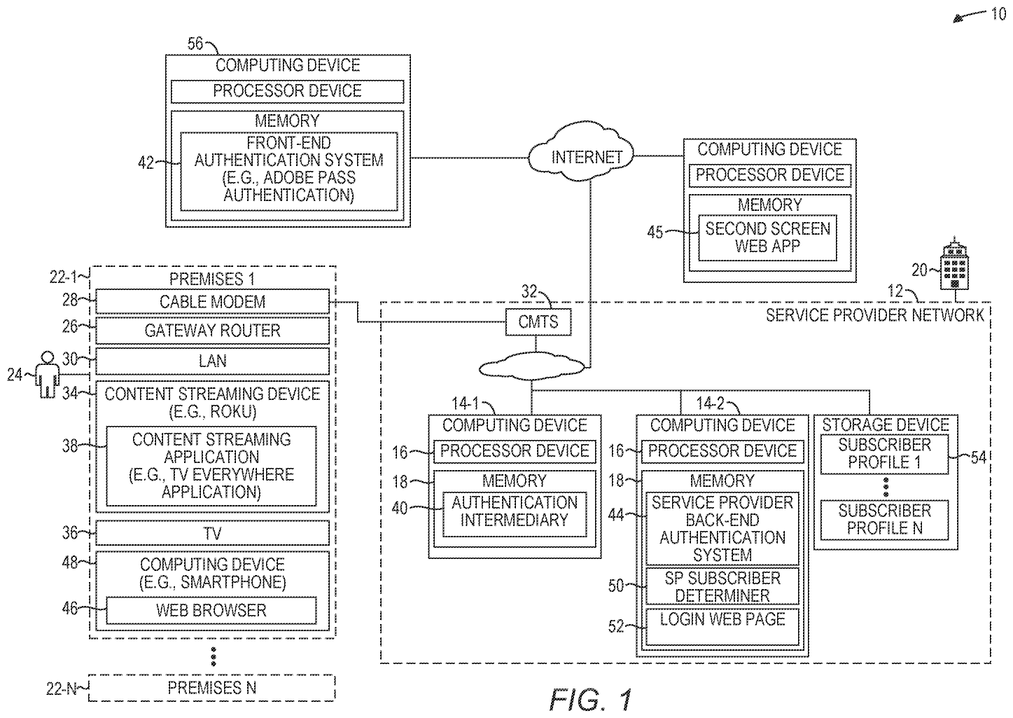

FIG. 1 is an environment 10 in which content streaming application authentication without a second screen application can be implemented according to some examples. The environment 10 includes a service provider network 12 that includes a plurality of computing devices 14-1-14-2 (generally, computing devices 14), each of which includes a processor device 16 and a memory 18. While solely for purposes of illustration various components will be illustrated as executing on the computing devices 14-1-14-2, it is noted that the components could execute in different operating environments including, by way of non-limiting example, virtual machine environments, cloud computing environments, or the like.

The service provider network 12 is operated by a service provider 20 that provides services to a plurality of premises 22-1-22-N(generally, premises 22). The services may include, by way of non-limiting example, broadband network access services and/or television subscription services. The service provider 20 may provide services to thousands, tens of thousands, or millions of different premises 22.

The premises 22-1 in this example is a residence, and the service provider 20 provides a user, such as a subscriber 24 associated with the premises 22-1 both broadband network access services (i.e., high-speed Internet access) and television subscription services. The services are provided in part via one or more CPE, including a gateway router 26 and a cable modem 28. The gateway router 26 implements a local area network (LAN) 30 in the premises 22-1 and communicates with other networks via the cable modem 28. The cable modem 28 is communicatively coupled to an aggregation device such as a cable modem termination system (CMTS) 32, which in turn is connected to other networking devices operated by the service provider 20 which collectively provide Internet connectivity to the gateway router 26 and devices connected to the LAN 30.

A content streaming device 34, in this example a Roku® CTV device, is connected to the LAN 30 and to a TV 36. The content streaming device 34 is a CTV device. The content streaming device 34 includes a content streaming application 38. The content streaming application 38 may be a TV Everywhere (TVE) streaming application (hereinafter a “TVE application” for the sake of brevity). TV Everywhere is a model and technology that allows subscribers, such as the subscriber 24, to view streaming content to which they subscribe on a broad spectrum of devices and platforms.

A TVE application ensures, prior to streaming content, that the subscriber 24 has been properly authenticated by the service provider with which the subscriber 24 has purchased the appropriate rights to view the streaming content. A TVE application typically ensures that the subscriber 24 is authenticated every so often, such as each month, every two months, or the like. TV Everywhere is an increasingly popular model for TV subscription providers because TV Everywhere allows a TV subscription provider to provide content streaming services in a manner similar to Over The Top (OTT) models, such as Netflix®.

Typically, in order to implement such authentication, a content streaming application, such as a TVE application, needs to be able to communicate with any service provider that may agree to provide the content, which may be tens or hundreds of service providers, such as, by way of non-limiting example, AT&T®, Charter® Communications, Cox Communications, Hulu®, Comcast®, Verizon®, and the like. Similarly, each such service provider must be able to communicate with any number of different content streaming applications, such as, by way of non-limiting example, A&E®, Bravo, Cartoon Network®, CNBC®, USA, and the like.

To facilitate communications between service providers and content streaming applications, front-end authentication systems have been developed that standardize authentication communications between content providers and service providers and eliminates the need for each content streaming application to implement a proprietary authentication protocol with each potential service provider. A front-end authentication system publishes specifications for the content streaming applications (e.g., a representational state transfer application programming interface (REST API)) that, if implemented by the content streaming application, will enable the content streaming application to establish authentication communications with any service provider that has also agreed to utilize the front-end authentication system. Similarly the front-end authentication system publishes specifications for the service providers that, if implemented by the service provider, will enable the service provider to establish authentication communications with any content streaming application that has also agreed to utilize the front-end authentication system. Accordingly, many content streaming applications and service providers utilize a front-end authentication system. Many content streaming applications and service providers utilize an Adobe® Pass (previously known as Adobe Primetime) front-end authentication system, although the examples are not limited to any particular front-end authentication system.

The front-end authentication system, during the authentication process, allows a service provider to present their own login screen to acquire whatever authentication credentials the service provider requires. A connected TV device often does not implement a web browser or, if a web browser is implemented, does not implement a mechanism to conveniently utilize the web browser in parallel during the authentication phase of a content streaming application. To overcome this limitation, the front-end authentication system may use the concept of a “second screen application” wherein the subscriber, during the authentication process, utilizes a second computing device, such as a smartphone, a laptop or desktop computing device, a tablet computing device, or the like, to enter authentication information for the particular service provider with which the subscriber has the relevant subscription. In practice, the front-end authentication system sends a message to the content streaming application that has a registration code and a URL that identifies the second screen application, typically a web page. The content streaming application presents the registration code and the URL on a display device. The subscriber enters the URL into the second computing device, enters the registration code, and selects a particular service provider from a list of service providers. The user is then automatically redirected to a login web application of the service provider. The subscriber enters their authentication credentials, and the service provider authenticates the subscriber (or does not). The subscriber may then be able to view content via the content streaming application.

The second screen application is typically developed by the content provider (i.e., the developer of the content streaming application) and communicates with both the front-end authentication system and the service provider's back-end authentication system to determine whether the subscriber has the appropriate subscription to view the streaming content. If so, the second screen application informs the front-end authentication system; the front-end authentication system informs the content streaming application; and the content streaming application allows the subscriber to view the streaming content.

In a situation where the service provider with which the subscriber has the appropriate subscription to view the streaming content is also the service provider from whom the subscriber obtains Internet access, it would be preferable if the service provider could detect that an authentication request is being made by a content streaming application from the same premises serviced by the service provider, automatically, and without user input, determine that the subscriber has the appropriate rights, and automatically inform the front-end authentication system that the subscriber is authenticated. This would eliminate the need for the subscriber to record a registration code, locate a second computing device, navigate to a particular URL, correctly type in the registration code, select a service provider, locate their authentication credentials for the service provider, and correctly type in their authentication credentials into a login form. This conventional authentication process is not popular among consumers.

The examples disclosed herein implement a multi-modal authentication intermediary 40 that, as will be discussed in greater detail below, eliminates the conventional manual entry of registration codes and service provider authentication credentials in situations where the service provider network 12 recognizes that a content streaming device, such as the content streaming device 34 is “behind” a CPE device, such as the cable modem 28 or the gateway router 26, provisioned by the service provider 20 to provide Internet access to the premises 22-1. Specifically, instead of interacting directly with a front-end authentication system 42, the content streaming application 38 may invoke the authentication intermediary 40 that operates in a second screen application emulation mode in certain circumstances to eliminate the need for a second screen application, and a second screen application pass-through mode in situations where it is appropriate to require the use of a second screen application. The authentication intermediary 40 retains all the benefits provided by the front-end authentication system 42 without requiring any modifications to the front-end authentication system 42. The authentication intermediary 40 also ensures appropriate authentication with a service provider back-end authentication system 44 maintained by the service provider 20. Thus, the authentication intermediary 40 seamlessly integrates a new feature into the authentication process that, in certain circumstances, completely but securely eliminates the need for the subscriber 24 to manually authenticate when running the content streaming application 38 in a manner that requires no modifications to existing front-end authentication technologies.

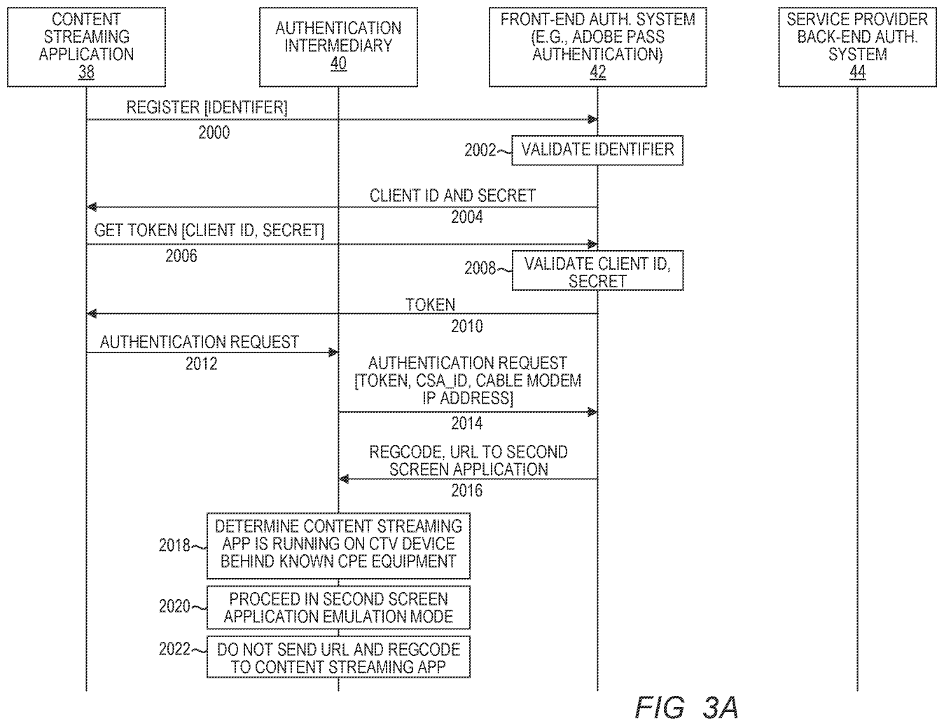

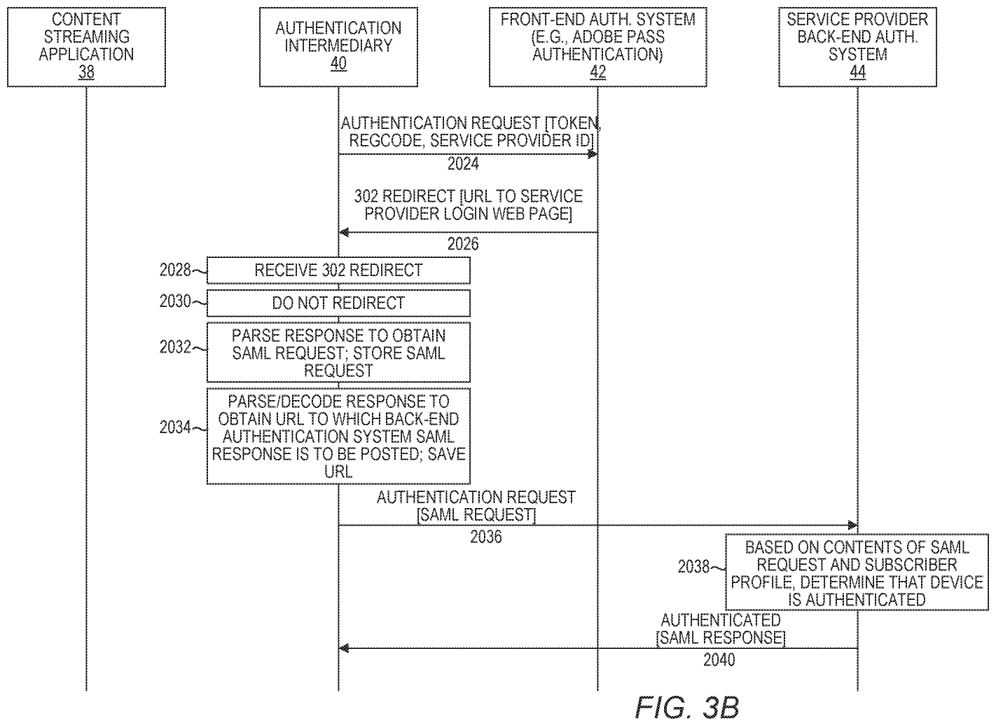

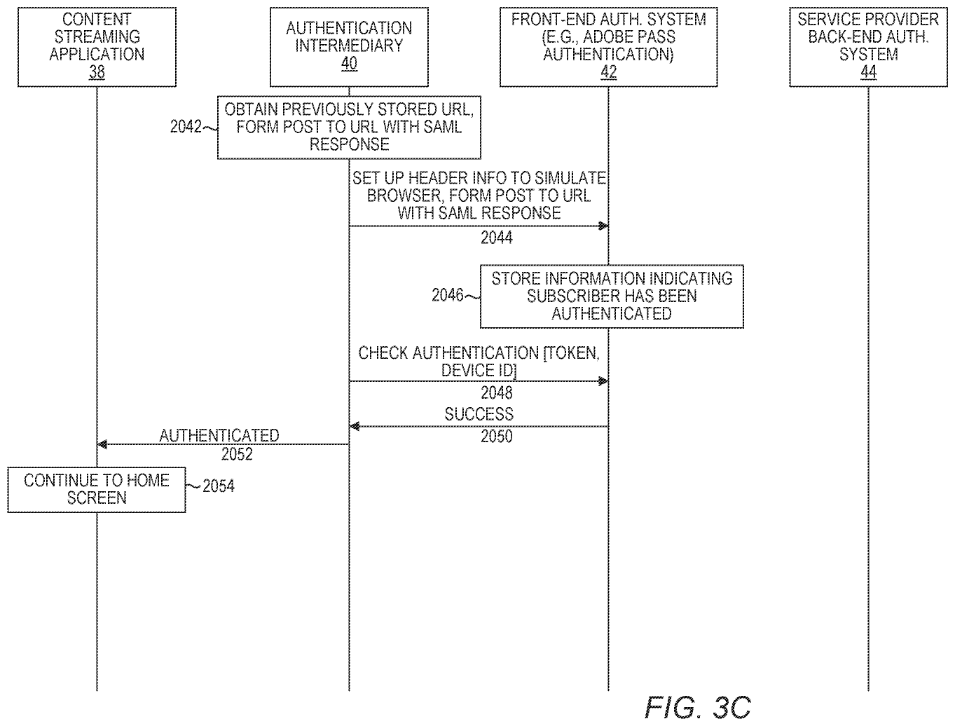

With this background, a simplified example of content streaming application authentication without a second screen application according to some implementations will now be discussed. A more detailed example of content streaming application authentication without a second screen application will be provided with reference to FIGS. 3A-3C, below. The subscriber 24 desires to view streaming content from the content streaming application 38, which, in this example, is a TV Everywhere content streaming application. The content streaming application 38 was originally developed to interface with the front-end authentication system 42, and has been modified to interoperate with the authentication intermediary 40. The subscriber 24 initiates the content streaming application 38 on the content streaming device 34. The content streaming application 38 determines that the subscriber 24 has not been authenticated, or has not been authenticated for a predetermined period of time, and thus initiates the authentication sequence. It is noted that, as used herein, authenticating the subscriber 24 is synonymous with authenticating the content streaming application 38. Thus, it may be said that the process described herein authenticates/authorizes the subscriber 24 or authenticates/authorizes the content screening application 38 since, in either case, the subscriber 24 will be permitted to view content via the content screening application 38 if the subscriber 24 has the appropriate rights to do so, as determined by the service provider back-end authentication system 44.

While not illustrated for purposes of simplicity, the initial communications may be directly between the content streaming application 38 and the front-end authentication system 42 to confirm with the front-end authentication system 42 that the content streaming application 38 has been previously identified to the front-end authentication system 42 for security purposes to eliminate the possibility of rogue content streaming applications attempting to breach security. If the front-end authentication system 42 determines that the content streaming application 38 is known and valid, the front-end authentication system 42 may provide the content streaming application 38 an access token that is subsequently submitted back to the front-end authentication system 42 during subsequent communications of the front-end authentication system 42. For purposes of illustration, it will be assumed that such initial communications between the content streaming application 38 and the front-end authentication system 42 have occurred, and that each communication between the content streaming application 38 and the authentication intermediary 40 includes the access token so that the authentication intermediary 40 can provide the access token on behalf of the content streaming application 38 when interfacing with the front-end authentication system 42.

After the content streaming application 38 obtains the access token, the content streaming application 38 sends an application authentication request to the authentication intermediary 40 to obtain a registration code and a URL to a second screen web application 45 via which the subscriber 24 can enter the registration code and select a particular service provider. The second screen web application 45 is developed by the developer of the content streaming application 38. The application authentication request includes the access token and a content streaming application identifier (ID) that identifies the content streaming application 38 to the front-end authentication system 42. The authentication intermediary 40 receives the application authentication request and sends a registration request to the front-end authentication system 42 that includes the access token and the content streaming application ID. The front-end authentication system 42 returns a registration code message that includes presentation information that includes a randomly generated registration code and the URL to the second screen web application 45.

The authentication intermediary 40 communicates with a service provider subscriber determiner 50 to determine if the authentication request originated from a network that is associated with a subscription of the service provider 20. In this example, header information in the application authentication request of the content streaming application 38 includes the public Internet protocol (IP) address of the cable modem 28. The authentication intermediary 40 extracts, from the authentication request, CPE information associated with a CPE device through which the authentication request traversed, in this example, the IP address of the cable modem 28. The IP address of the cable modem 28 may have been provisioned by the service provider 20 and, thus, is known to the service provider 20, or the service provider 20 may otherwise have been provided the IP address of the cable modem 28. The authentication intermediary 40 provides the CPE information to the service provider subscriber determiner 50. The service provider subscriber determiner 50 accesses information and determines that the public IP address of the cable modem 28 is an IP address owned and provided to the cable modem 28 by the service provider 20. The service provider subscriber determiner 50 responds to the authentication intermediary 40 indicating that the authentication request originated from a network that is associated with a subscription of the service provider 20.

In response, the authentication intermediary 40 enters a second screen application emulation mode wherein the authentication intermediary 40 will emulate the second screen web application 45 in a manner that is transparent to the front-end authentication system 42 and that eliminates a need for the subscriber 24 to enter authentication credentials.

If the service provider subscriber determiner 50 had responded to the authentication intermediary 40 indicating that the authentication request did not originate from a network that is associated with a subscription of the service provider 20, the authentication intermediary 40 would set the mode of the authentication intermediary 40 to a second screen application pass-through mode wherein the authentication would proceed normally and would be facilitated by the second screen web application 45 that the subscriber 24 would initiate on a computing device 48. In particular, the authentication intermediary 40 would provide the presentation information received from the front-end authentication system 42 that includes the registration code and the URL to the second screen web application to the content streaming application 38. The content streaming application 38 would present the information on the TV 36 and the subscriber 24 would enter the URL into a web browser 46 executing on the computing device 48. The subscriber 24 would enter the registration code and then select the service provider 20 from a list of service providers. The subscriber 24 would then automatically, via a hypertext transfer protocol (HTTP) redirect, be redirected to a service provider login web page 52 of the service provider 20. The subscriber 24 would enter the authentication credentials of the subscriber 24 that were previously arranged with the service provider 20. The service provider back-end authentication system 44 would validate the authentication credentials. The second screen web application 45 would send a response to the front-end authentication system 42 that the subscriber 24 has been authenticated. The front-end authentication system 42 would inform the content streaming application 38 that the subscriber 24 has been authenticated.

In this example, because the authentication request originated from a network that is associated with a subscription of the service provider 20 and the authentication intermediary 40 is in the second screen application emulation mode, the authentication intermediary 40 disregards the URL of the second screen application and begins emulating the second screen application. The authentication intermediary 40 does not communicate the registration code and the URL to the content streaming application 38. The authentication intermediary 40 instead sends an authentication request to the front-end authentication system 42 that emulates the authentication request that would be sent by the second screen web application 45 after the subscriber 24 has selected a particular service provider. The authentication request includes a service provider ID of the service provider 20 known to the front-end authentication system 42 to correspond to the service provider 20.

In response, the front-end authentication system 42 generates an authentication message that identifies a URL of the service provider login web page 52 for user entry of subscriber authentication credentials. The authentication message also includes a service provider authentication request that has been formatted in a predetermined format expected by the service provider back-end authentication system 44. The service provider authentication request may be encrypted and may only be able to be decrypted by the service provider back-end authentication system 44. The authentication message may be in the form of an HTTP 302 redirect that requests a redirect to the URL of the service provider login web page 52, where the subscriber 24 would be requested to enter the authentication credentials of the subscriber 24.

The authentication intermediary 40 prevents the service provider login web page 52 identified by the URL from being presented on a display device by inhibiting the URL from being sent to another computing device. In implementations where the authentication intermediary 40 provides the functionality described herein for multiple back-end authentication systems, the authentication intermediary 40 may use the URL to identify the appropriate service provider back-end authentication system for authenticating the subscriber 24.

In other implementations where the authentication intermediary 40 provides the functionality described herein for multiple back-end authentication systems (e.g., multiple service providers), the authentication intermediary 40 may use other information, such as the IP address of the cable modem 28 to identify the appropriate service provider back-end authentication system for authenticating the subscriber 24.

The authentication intermediary 40 generates a back-end authentication request that includes the service provider authentication request received from the front-end authentication system 42 and information identifying the subscriber 24, such as the public IP address of the cable modem 28. The authentication intermediary 40 sends the back-end authentication request to the service provider back-end authentication system 44. The service provider back-end authentication system 44 accesses a subscriber profile 54 that corresponds to the subscriber 24. Based on the subscriber profile 54, the service provider back-end authentication system 44 authenticates the subscriber 24 and generates a service provider authentication response in a format expected by the front-end authentication system 42. The service provider back-end authentication system 44 sends the service provider authentication response to the authentication intermediary 40. The service provider authentication response may be encrypted. The authentication intermediary 40 sends the service provider authentication response to the front-end authentication system 42. The front-end authentication system 42 receives the service provider authentication response and determines that the subscriber 24 has been authenticated. The authentication intermediary 40 sends a message to the content streaming application 38 indicating that the subscriber 24 has been authenticated and authorized to view the content. The content streaming application 38 proceeds to a home screen of the content streaming application 38 to allow the subscriber 24 to begin viewing content.

It is noted that the front-end authentication system 42 may execute on a computing device in the service provider network 12, or, in an alternative implementation as illustrated in FIG. 1, may execute on a computing device 56 that is located outside of the service provider network 12. In some implementations, the computing device 56 may be operated by the manufacturer of the front-end authentication system 42.

It is further noted that, because the authentication intermediary 40 is a component of the computing device 14-1, functionality implemented by the authentication intermediary 40 may be attributed to the computing device 14-1 generally. Moreover, in examples where the authentication intermediary 40 comprises software instructions that program the processor device 16 to carry out functionality discussed herein, functionality implemented by the authentication intermediary 40 may be attributed herein to the processor device 16.

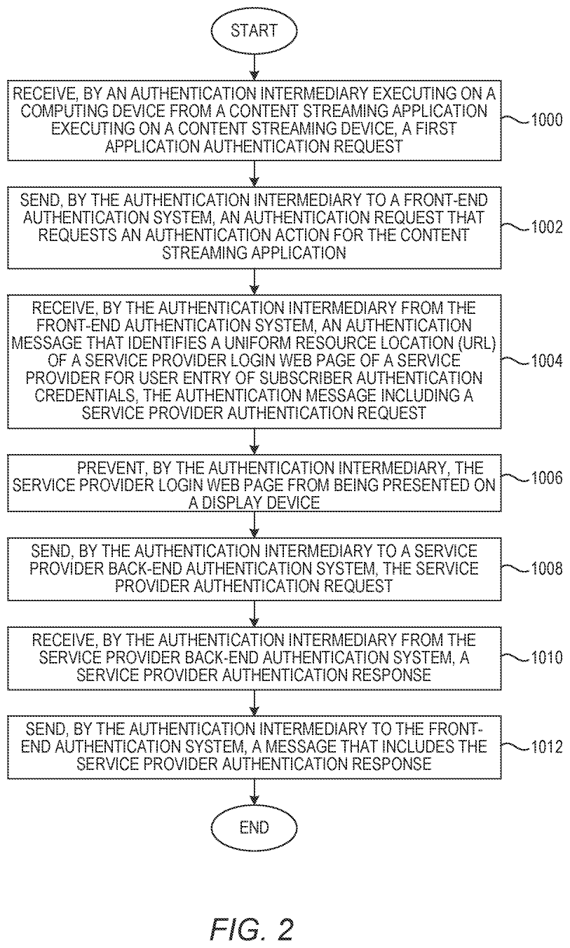

FIG. 2 is a flowchart of a method for content streaming application authentication without a second screen application according to one implementation. FIG. 2 will be discussed in conjunction with FIG. 1. The authentication intermediary 40 receives, from the content streaming application 38 executing on the content streaming device 34, a first application authentication request (FIG. 2, block 1000). The authentication intermediary 40 sends, to the front-end authentication system 42, an authentication request that requests an authentication action for the content streaming application 38 (FIG. 2, block 1002). The authentication intermediary 40 receives, from the front-end authentication system 42, an authentication action that comprises an authentication message that identifies a URL of the service provider login web page 52 of the service provider 20 for user entry of subscriber authentication credentials, the authentication message including a service provider authentication request (FIG. 2, block 1004). The authentication intermediary 40 prevents the service provider login web page 52 from being presented on a display device (FIG. 2, block 1006). The authentication intermediary 40 sends, to the service provider back-end authentication system 44, the service provider authentication request (FIG. 2, block 1008). The authentication intermediary 40 receives, from the service provider back-end authentication system 44, a service provider authentication response (FIG. 2, block 1010). The authentication intermediary 40 sends, to the front-end authentication system 42, a message that includes the service provider authentication response (FIG. 2, block 1012).

FIGS. 3A-3C illustrate a sequence diagram illustrating actions taken by and messages communicated between components illustrated in FIG. 1 to implement content streaming application authentication without a second screen application according to some examples. The content streaming application 38 sends a registration message to the front-end authentication system 42 (FIG. 3A, step 2000). The registration message may include any suitable information required by the front-end authentication system 42 to comply with the security implemented by the front-end authentication system 42. For example, in order to communicate with the front-end authentication system 42 the front-end authentication system 42 may require that the content streaming application 38 be pre-registered with a particular signature, such a JSON Web Token or the like. In order to start the authentication process, the content streaming application 38 may need to include the signature in the registration message. The front-end authentication system 42 validates that the signature matches the pre-registered signature, and thus confirms that the content streaming application 38 is legitimate and not a rogue application (FIG. 3A, step 2002).

The front-end authentication system 42 sends a client identifier and a secret to the content streaming application 38 (FIG. 3A, step 2004). The content streaming application 38 receives the client identifier and the secret, and sends the client identifier and the secret to an entrypoint of the front-end authentication system 42 that returns an access token (FIG. 3A, step 2006). The front-end authentication system 42 verifies that the client ID and secret are correct, and issues an access token to the content streaming application 38 (FIG. 3A, steps 2008, 2010). The front-end authentication system 42 requires that the access token be provided during subsequent authentication steps. It is noted that these are simply example registration steps required by the front-end authentication system 42 to ensure that the content streaming application 38 is a valid and known content streaming application, and that in other implementations the front-end authentication system 42 may require more, fewer, or different registration steps than those discussed herein.

The content streaming application 38 then sends an application authentication request to the authentication intermediary 40 requesting authentication (FIG. 3A, step 2012). The authentication intermediary 40 may utilize any desired inter-process communication protocol to communicate with the content streaming application 38. In some implementations, the authentication intermediary 40 utilizes a REST API to communicate with the content streaming application 38. The content streaming application 38 includes in the application authentication request the access token and a content streaming ID of the content streaming application 38 that is known to the front-end authentication system 42.

The authentication intermediary 40 sends an authentication request to a registration endpoint of the front-end authentication system 42 (FIG. 3A, step 2014). The authentication request includes the access token and the content streaming application ID. The front-end authentication system 42 responds with a registration code message that includes presentation information including a registration code and a URL to the second screen web application 45 for presentation by the content streaming application 38 to the subscriber 24 so that the subscriber 24 can enter the URL in a web browser and enter the registration code (FIG. 3A, step 2016).

The authentication intermediary 40 communicates with the service provider subscriber determiner 50 to determine if the authentication request from the content streaming application 38 originated from a network that is associated with a subscription of the service provider 20 (FIG. 3A, step 2018). In this example, header information in the authentication request of the content streaming application 38 includes the public IP address of the cable modem 28, and the authentication intermediary 40 provides the public IP address of the cable modem 28 to the service provider subscriber determiner 50. It is noted that the public IP address of the cable modem 28 is just one example of data that may be used by the service provider subscriber determiner 50 and that in other implementations other suitable data that may be present either in the payload or header of the authentication request from the content streaming application 38 may be used by the service provider subscriber determiner 50.

The service provider subscriber determiner 50 accesses information and determines that the public IP address of the cable modem 28 is an IP address owned and provided to the cable modem 28 by the service provider 20. The service provider subscriber determiner 50 responds to the authentication intermediary 40 indicating that the authentication request originated from a network that is associated with a subscription of the service provider 20.

In another example implementation, instead of the authentication intermediary 40 invoking the service provider subscriber determiner 50, the content streaming application 38 may invoke the service provider subscriber determiner 50 and receive a response that indicates that the authentication request originated from a network that is associated with a subscription of the service provider 20. The content streaming application 38 includes this information in the authentication request to the authentication intermediary 40.

In response, the authentication intermediary 40 determines that the authentication intermediary 40 should proceed in the second screen application emulation mode wherein the authentication intermediary 40 will emulate the second screen web application 45 in a manner that is transparent to the front-end authentication system 42 and that eliminates the need for the subscriber 24 to utilize the second screen web application 45 to authenticate.

The authentication intermediary 40 does not send the URL and the registration code to the content streaming application 38 (FIG. 3A, step 2022). Referring now to FIG. 3B, the authentication intermediary 40 simulates the response that would be generated by the second screen web application 45. Specifically, in lieu of sending the presentation information to the content streaming application 38, the authentication intermediary 40 generates a message that includes the registration code and indicates that the subscriber 24 selected the service provider 20 from a list of service providers. The authentication intermediary 40 sends the message to the front-end authentication system 42 (FIG. 3B, step 2024). The front-end authentication system 42 generates an authentication message that identifies a URL of the service provider login web page 52 for user entry of subscriber authentication credentials. The authentication message also includes a service provider authentication request that has been formatted in a predetermined format expected by the service provider back-end authentication system 44. The service provider authentication request includes information sufficient for the service provider back-end authentication system 44 to determine whether the subscriber 24 can be authenticated. The service provider authentication request may be encrypted and may only be able to be decrypted by the service provider back-end authentication system 44. The authentication message may be in the form of an HTTP 302 redirect that requests a redirect to the URL of the service provider login web page 52, where the subscriber 24 would be requested to enter the authentication credentials of the subscriber 24. The authentication message also includes a URL to which the service provider authentication response generated by the service provider back-end authentication system 44 is to be sent. The front-end authentication system 42 sends the authentication message to the authentication intermediary 40 (FIG. 3B, step 2026).

The authentication intermediary 40 receives the authentication message (FIG. 3B, step 2028). The authentication intermediary 40 prevents the service provider login web page 52 identified by the URL from being presented on a display device by inhibiting the URL from being sent to another computing device (FIG. 3B, step 2030). The authentication intermediary 40 parses the authentication message to extract the service provider authentication request (FIG. 3B, step 2032). The authentication intermediary 40 parses the authentication message to identify a response destination to which the service provider authentication response is to be sent. In this example, the response destination is identified by a URL. The authentication intermediary 40 parses the authentication message to identify the URL to which the service provider authentication response is to be sent and stores the URL (FIG. 3B, step 2034). The authentication intermediary 40 generates a back-end authentication request that includes the service provider authentication request received from the front-end authentication system 42 and includes information identifying the subscriber 24, such as the public IP address of the cable modem 28. The authentication intermediary 40 sends the back-end authentication request to the service provider back-end authentication system 44 (FIG. 3B, step 2036). The service provider back-end authentication system 44 accesses a subscriber profile 54 that corresponds to the subscriber 24. In this example, the service provider back-end authentication system 44 determines that the subscriber 24 has the appropriate subscription to view the content streaming application 38 (FIG. 3B, step 2038). The service provider back-end authentication system 44 authenticates the subscriber 24 and generates a service provider authentication response in a format expected by the front-end authentication system 42. The service provider back-end authentication system 44 sends the service provider authentication response to the authentication intermediary 40 (FIG. 3B, step 2040). The service provider authentication response may be encrypted.

Referring now to FIG. 3C, the authentication intermediary 40 accesses the previously stored URL to which the service provider authentication response is to be sent (FIG. 3C, step 2042). The URL may be a particular endpoint of an API of the front-end authentication system 42. The front-end authentication system 42 expects a response from the second screen web application 45 which is a browser-based web application. The authentication intermediary 40 generates a message with appropriate header information such that the message appears to have originated from a web browser application and sends the message to the front-end authentication system 42 (FIG. 3C, step 2044). The message may be sent via a form post to the URL.

The front-end authentication system 42 receives the message and determines that the subscriber 24 has been authenticated. The front-end authentication system 42 may then store information that indicates that the subscriber 24 has been authenticated (FIG. 3C, step 2046). The authentication intermediary 40 may then send the front-end authentication system 42 an authentication request to confirm that the front-end authentication system 42 has authenticated the subscriber 24 (FIG. 3C, step 2048). The front-end authentication system 42 responds with a confirmation, and the authentication intermediary 40 sends a message to the content streaming application 38 indicating that the subscriber 24 has been authenticated (FIG. 3C, steps 2050, 2052). The content streaming application 38 proceeds to a home screen of the content streaming application 38 to allow the subscriber 24 to begin viewing content (FIG. 3C, step 2054).

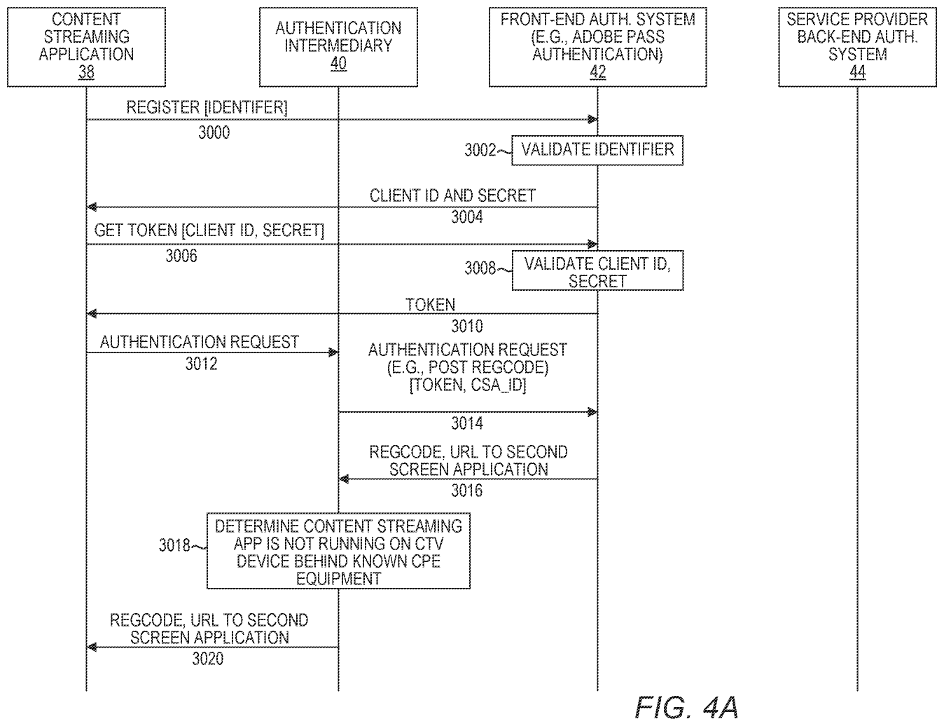

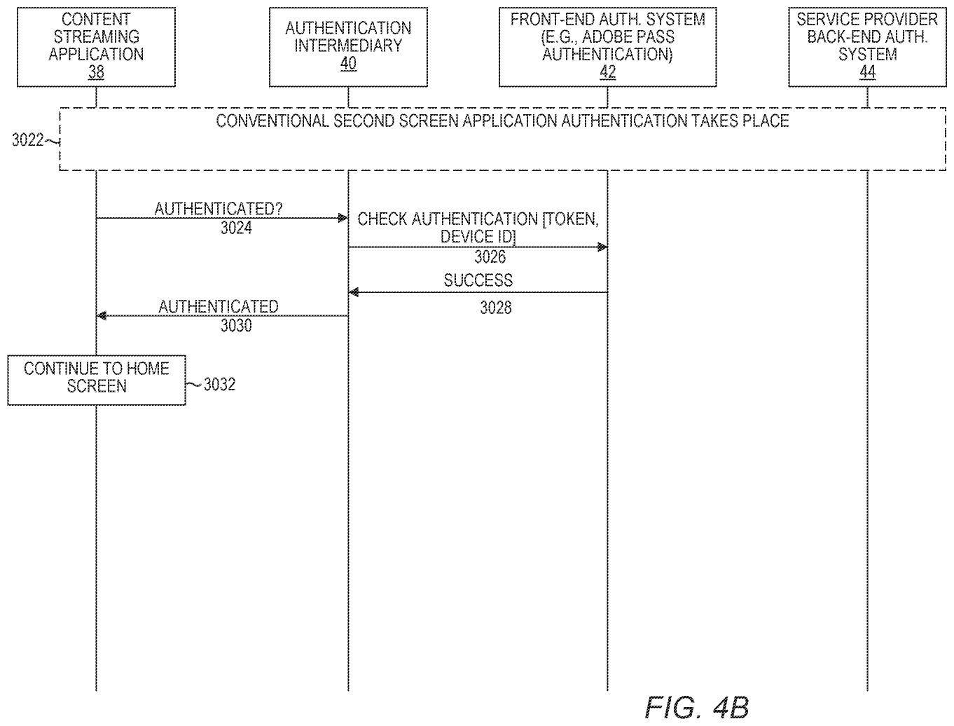

FIGS. 4A-4B illustrate a sequence diagram illustrating actions taken by and messages communicated between components illustrated in FIG. 1 to implement content streaming application authentication with a second screen application according to some examples. In this example, the subscriber 24 has disconnected the content streaming device 34 from the LAN 30 and connected the content streaming device 34 to a LAN in a remote location, such as a vacation home. The subscriber 24 then initiates the content streaming application 38. Steps 3000-3016 are identical to steps 2000-2016 discussed above with regard to FIG. 3A, and, for the sake of brevity, the discussion relating to the steps 2000-2016 will not be repeated. In this example, the authentication intermediary 40 communicates with the service provider subscriber determiner 50 to determine if the authentication request originated from a network that is associated with a subscription of the service provider 20. In this example, the authentication intermediary 40 includes the public IP address of the cable modem of the vacation home to the service provider subscriber determiner 50. The service provider subscriber determiner 50 accesses information and determines that the public IP address of the cable modem to which the content streaming device 34 is now connected is not an IP address owned and provided by the service provider 20. The service provider subscriber determiner 50 responds to the authentication intermediary 40 indicating that the authentication request did not originate from a network that is associated with a subscription of the service provider 20 (FIG. 4A, step 3018).

In response, the authentication intermediary 40 sends the registration code and the URL to the second screen web application 45 to the content streaming application 38 for presentation to the subscriber 24 (FIG. 4A, step 3020). Referring now to FIG. 4B, the subscriber 24 and the second screen web application 45 operate in a conventional manner with the front-end authentication system 42 and the service provider back-end authentication system 44 to authenticate the subscriber 24 (FIG. 4B, step 3022). The second screen web application 45 may subsequently send an authentication query to the authentication intermediary 40 to determine if the subscriber 24 has been authenticated (FIG. 4B, step 3024). The authentication intermediary 40 sends the front-end authentication system 42 an authentication request to confirm that the front-end authentication system 42 has authenticated the subscriber 24 (FIG. 4B, 3026). The front-end authentication system 42 responds with a confirmation, and the authentication intermediary 40 sends a message to the content streaming application 38 indicating that the subscriber 24 has been authenticated (FIG. 4B, steps 3028, 3030). The content streaming application 38 proceeds to a home screen of the content streaming application 38 to allow the subscriber 24 to begin viewing content (FIG. 4B, 3032).

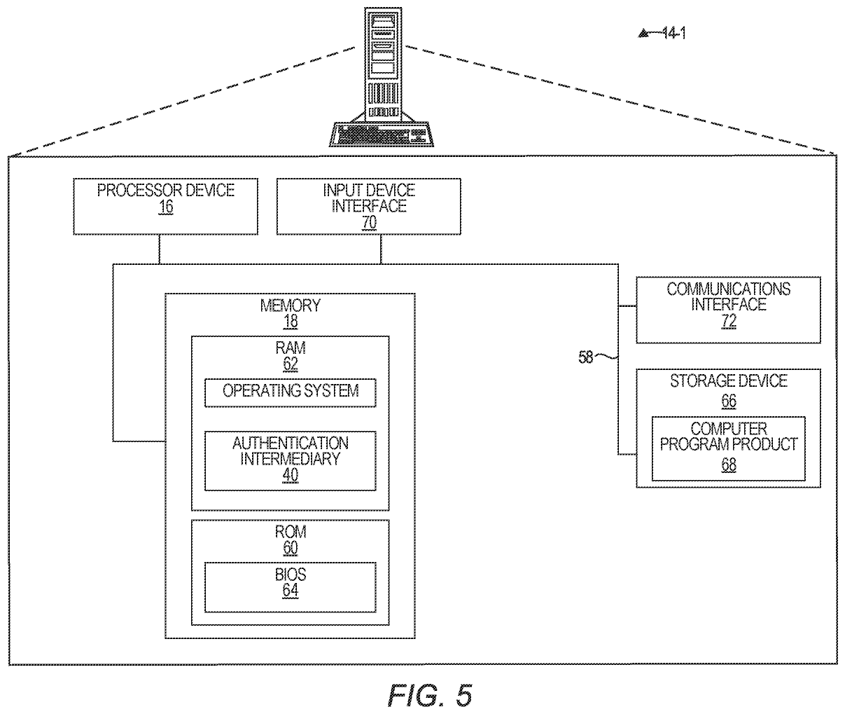

FIG. 5 is a block diagram of a computing device suitable for implementing examples disclosed herein according to some implementations. The computing device 14-1 may comprise any computing or electronic device capable of including firmware, hardware, and/or executing software instructions to implement the functionality described herein, such as a computer server, a desktop computing device, a special purpose network processing device or the like. The computing device 14-1 includes the processor device 16, the system memory 18, and a system bus 58. The system bus 58 provides an interface for system components including, but not limited to, the system memory 18 and the processor device 16. The processor device 16 can be any commercially available or proprietary processor.

The system bus 58 may be any of several types of bus structures that may further interconnect to a memory bus (with or without a memory controller), a peripheral bus, and/or a local bus using any of a variety of commercially available bus architectures. The system memory 18 may include non-volatile memory 60 (e.g., read-only memory (ROM), erasable programmable read-only memory (EPROM), electrically erasable programmable read-only memory (EEPROM), etc.), and volatile memory 62 (e.g., random-access memory (RAM)). A basic input/output system (BIOS) 64 may be stored in the non-volatile memory 60 and can include the basic routines that help to transfer information between elements within the computing device 14-1. The volatile memory 62 may also include a high-speed RAM, such as static RAM, for caching data.

The computing device 14-1 may further include or be coupled to a non-transitory computer-readable storage medium such as a storage device 66, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 66 and other drives associated with computer-readable media and computer-usable media may provide non-volatile storage of data, data structures, computer-executable instructions, and the like.

A number of modules can be stored in the storage device 66 and in the volatile memory 62, including an operating system and one or more program modules, such as the authentication intermediary 40, which may implement the functionality described herein in whole or in part. All or a portion of the examples may be implemented as a computer program product 68 stored on a transitory or non-transitory computer-usable or computer-readable storage medium, such as the storage device 66, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16. The processor device 16, in conjunction with the authentication intermediary 40 in the volatile memory 62, may serve as a controller, or control system, for the computing device 14-1 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 16 through an input device interface 70 that is coupled to the system bus 58 but can be connected by other interfaces such as a parallel port, an Institute of Electrical and Electronic Engineers (IEEE) 1394 serial port, a Universal Serial Bus (USB) port, an IR interface, and the like. The computing device 14-1 may also include a communications interface 72 suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by an authentication intermediary executing on a computing device from a content streaming application executing on a content streaming device, a first application authentication request;
sending, by the authentication intermediary to a front-end authentication system, an authentication request that requests an authentication action for the content streaming application;
receiving, by the authentication intermediary from the front-end authentication system, an authentication message that identifies a uniform resource locator (URL) of a service provider login web page for user entry of subscriber authentication credentials, the authentication message including a service provider authentication request;
preventing, by the authentication intermediary, the service provider login web page from being presented on a display device;
sending, by the authentication intermediary to a service provider back-end authentication system, the service provider authentication request;
receiving, by the authentication intermediary from the service provider back-end authentication system, a service provider authentication response; and
sending, by the authentication intermediary to the front-end authentication system, a message that includes the service provider authentication response.

2. The method of claim 1, wherein the first application authentication request comprises an access token associated with the content streaming application, the service provider providing content streaming services to a plurality of subscribers.

3. The method of claim 2, wherein the authentication request includes the access token.

4. The method of claim 1, further comprising:
prior to sending the authentication request to the front-end authentication system, receiving, by the authentication intermediary from the front-end authentication system, a first registration code message that includes first presentation information for presentation to a user of the content streaming application, the first presentation information comprising a first registration code and a URL identifying a location of a second screen application via which the first registration code is to be entered;
determining, by the authentication intermediary, that the first application authentication request originated from a network associated with a subscription of the service provider; and
in response to determining that the first application authentication request originated from a network associated with a subscription of the service provider:
inhibiting the sending of the URL to the content streaming device; and
sending, by the authentication intermediary to the front-end authentication system, the authentication request that requests the authentication action for the content streaming application.

5. The method of claim 4, wherein determining that the first application authentication request originated from a network associated with a subscription of the service provider comprises accessing data in the first application authentication request that indicates that the first application authentication request originated from a network associated with a subscription of the service provider.

6. The method of claim 4, wherein determining that the first application authentication request originated from a network associated with a subscription of the service provider comprises:
extracting, by the authentication intermediary, from the first application authentication request, customer premises equipment (CPE) information associated with a CPE device through which the first application authentication request traversed;
sending, by the authentication intermediary to a service provider subscriber determiner, the CPE information; and
receiving, by the authentication intermediary from the service provider subscriber determiner, information that indicates that the first application authentication request originated from a network associated with a subscription of the service provider.

7. The method of claim 4, further comprising:
subsequently receiving, by the authentication intermediary executing on the computing device from the content streaming application executing on the content streaming device, a second application authentication request;
receiving, by the authentication intermediary from the front-end authentication system, a second registration code message that includes second presentation information for presentation to a user of the content streaming application, the second presentation information comprising a second registration code and the URL identifying the location of the second screen application via which the second registration code is to be entered;
determining, by the authentication intermediary, that the second application authentication request did not originate from a network associated with a subscription of the service provider;
in response to determining, by the authentication intermediary, that the second application authentication request did not originate from a network associated with a subscription of the service provider, entering a second screen application pass-through mode; and
sending the second registration code message to the content streaming device for presentation of the second registration code and the URL identifying the location of the second screen application via which the second registration code is to be entered.

8. The method of claim 1, further comprising:
prior to sending the authentication request to the front-end authentication system, in response to the first application authentication request, requesting, by the authentication intermediary from the front-end authentication system, a registration code for the content streaming application; and
receiving, by the authentication intermediary from the front-end authentication system, a registration code message that includes presentation information for presentation to a user of the content streaming application, the presentation information comprising a registration code and a URL identifying a location of a second screen application via which the registration code is to be entered.

9. The method of claim 8, further comprising:
disregarding, by the authentication intermediary, the URL identifying the location of the second screen application;
extracting, by the authentication intermediary, the registration code from the registration code message; and
in lieu of sending the presentation information to the content streaming application, sending, by the authentication intermediary to the front-end authentication system, the authentication request that requests the authentication action for the content streaming application, the authentication request including the registration code.

10. The method of claim 1, further comprising:
parsing, by the authentication intermediary, the authentication message to identify a response destination to which the service provider authentication response is to be sent;
storing, by the authentication intermediary, the response destination; and
wherein sending, by the authentication intermediary to the front-end authentication system, the message that includes the service provider authentication response comprises sending, by the authentication intermediary to the response destination, the message that includes the service provider authentication response.

11. The method of claim 10, wherein the response destination is an application programming interface (API) endpoint.

12. The method of claim 1, wherein the authentication intermediary is not a web browser, and wherein sending, by the authentication intermediary to the front-end authentication system, the message that includes the service provider authentication response further comprises:
formatting, by the authentication intermediary, the message as a web browser-originated message such that the message appears to the front-end authentication system that the authentication intermediary is a web browser.

13. The method of claim 1, wherein receiving the authentication message that identifies the URL of the service provider login web page further comprises:
receiving, by the authentication intermediary from the front-end authentication system, a hypertext transfer protocol (HTTP) redirect request that includes the authentication message that identifies the URL of the service provider login web page for user entry of the subscriber authentication credentials, the authentication message including the service provider authentication request; and
wherein preventing, by the authentication intermediary, the service provider login web page from being presented on the display device further comprises disregarding the HTTP redirect request to redirect to the URL of the service provider login web page.

14. The method of claim 1, further comprising:
sending, by the authentication intermediary to the content streaming application, information indicating that the content streaming application has been authenticated.

15. A computing device, comprising:
a memory; and
a processor device coupled to the memory and operable to:
receive, from a content streaming application executing on a content streaming device, a first application authentication request;
send, to a front-end authentication system, an authentication request that requests an authentication action for the content streaming application;
receive, from the front-end authentication system, an authentication message that identifies a uniform resource locator (URL) of a service provider login web page for user entry of subscriber authentication credentials, the authentication message including a service provider authentication request;
prevent the service provider login web page from being presented on a display device;
send, to a service provider back-end authentication system, the service provider authentication request;
receive, from the service provider back-end authentication system, a service provider authentication response; and
send, to the front-end authentication system, a message that includes the service provider authentication response.

16. The computing device of claim 15, wherein the processor device is further operable to:
prior to sending the authentication request to the front-end authentication system, receive, from the front-end authentication system, a first registration code message that includes first presentation information for presentation to a user of the content streaming application, the first presentation information comprising a first registration code and a URL identifying a location of a second screen application via which the first registration code is to be entered;
determine that the first application authentication request originated from a network associated with a subscription of the service provider; and
in response to determining that the first application authentication request originated from a network associated with a subscription of the service provider:
inhibit the sending of the URL identifying the location of the second screen application to the content streaming device; and
send, to the front-end authentication system, the authentication request that requests the authentication action for the content streaming application.

17. The computing device of claim 15, wherein the processor device is further operable to:
prior to sending the authentication request to the front-end authentication system, in response to the first application authentication request, request, from the front-end authentication system, a registration code for the content streaming application; and
receive, from the front-end authentication system, a registration code message that includes presentation information for presentation to a user of the content streaming application, the presentation information comprising a registration code and a URL identifying a location of a second screen application via which the registration code is to be entered.

18. The computing device of claim 15, wherein the processor device is further operable to:
parse the authentication message to identify a response destination to which the service provider authentication response is to be sent;
store the response destination; and
wherein to send, to the front-end authentication system, the message that includes the service provider authentication response, the processor device is further operable to send, to the response destination, the message that includes the service provider authentication response.

19. A non-transitory computer-readable storage medium that includes executable instructions operable to cause one or more processor devices to:
receive, from a content streaming application executing on a content streaming device, a first application authentication request;
send, to a front-end authentication system, an authentication request that requests an authentication action for the content streaming application;
receive, from the front-end authentication system, an authentication message that identifies a uniform resource locator (URL) of a service provider login web page for user entry of subscriber authentication credentials, the authentication message including a service provider authentication request;
prevent the service provider login web page from being presented on a display device;
send, to a service provider back-end authentication system, the service provider authentication request;
receive, from the service provider back-end authentication system, a service provider authentication response; and
send, to the front-end authentication system, a message that includes the service provider authentication response.

20. The non-transitory computer-readable storage medium of claim 19, wherein the instructions are further operable to cause the processor device to:
prior to sending the authentication request to the front-end authentication system, receive, from the front-end authentication system, a first registration code message that includes first presentation information for presentation to a user of the content streaming application, the first presentation information comprising a first registration code and a URL identifying a location of a second screen application via which the first registration code is to be entered;
determine that the first application authentication request originated from a network associated with a subscription of the service provider; and
in response to determining that the first application authentication request originated from a network associated with a subscription of the service provider:
inhibit the sending of the URL identifying the location of the second screen application to the content streaming device; and
send, to the front-end authentication system, the authentication request that requests the authentication action for the content streaming application.
